(19) United States
(12) Patent Application Publication
(10) Pub. No.: US 2006/0083495 A1
(43) Pub. Date: Apr. 20, 2006

(54) Variable heater element for low to high temperature ranges

(76) Inventor: Qiu Taiquing, Los Gatos, CA (US)

Correspondence Address: DORSEY & WHITNEY LLP, 555 CALIFORNIA STREET, SUITE 1000, SUITE 1000, SAN FRANCISCO, CA, 94104, US

(21) Appl. No.: 10/521,283

(22) PCT Filed: Jul. 10, 2003
(86) PCT No.: PCT/US03/21648

§ 371 Date: Feb. 28, 2005

Related U.S. Application Data
(60) Provisional application No. 60/396,536, filed on Jul. 15, 2002.
(60) Provisional application No. 60/428,526, filed on Nov. 22, 2002.

(51) Int. Cl. F27B 5/14

(52) U.S. Cl. 392/416; 219/411

(57) ABSTRACT

A method and apparatus for insulating and controlling temperature in a semiconductor manufacturing environment. The invention comprises at least one modular heater element designed to be mounted about a semiconductor furnace process chamber in order to minimize thermal transfer between the furnace interior and exterior. A base ring or cylinder (200, 500, 700) also referred to as a heater ring is sized to be fitted around an inner skin of a semiconductor mini-batch furnace. The base ring (200, 500, 700) has multiple channels (220, 520) equidistantly spaced about its inner perimeter. Heating coils of a type well known in the art may nest in these channels in order to warm the furnace interior. The coils may be either removably or permanently affixed within the channels.

### CROSS-REFERENCE TO RELATED APPLICATIONS

The present application claims the benefit of and priority from commonly assigned U.S. Provisional Patent Application Ser. No. 60/396,536, entitled Thermal Processing System, and filed Jul. 15, 2002, and No. 60/428,526, entitled Thermal Processing System and Method for Using the Same, and filed Nov. 22, 2002, both of which are incorporated herein by reference in their entirety.

### BACKGROUND OF THE INVENTION

1. Technical Field

This invention relates generally to a method and apparatus for insulating and heating a semiconductor manufacturing environment, and more specifically to a selectably insulating heater element appropriate for use in wide temperature ranges with a minibatch furnace.

2. Description of Related Art

Furnaces are commonly used in a wide variety of industries, including in the manufacture of integrated circuits or semiconductor devices from semiconductor substrates or wafers. Thermal processing of semiconductor wafers include, for example, heat treating, annealing, diffusion or driving of dopant material, deposition or growth of layers of material, and etching or removal of material from the substrate. These processes often call for the wafer to be heated to a temperature as high as 250 to 1200 degrees Celsius before and during the process. Moreover, these processes typically require that the wafer be maintained at a uniform temperature throughout the process, despite fluctuations in the temperature of the process gas or the rate at which it is introduced into the process chamber.

A conventional furnace typically consists of a voluminous process chamber positioned in or surrounded by a furnace. The furnace typically has multiple interconnected heating coils. Substrates to be thermally processed are sealed in the process chamber, which is then heated by the furnace to a desired temperature at which the processing is performed. For many processes, such as chemical vapor deposition, the sealed process chamber is first evacuated, after which reactive or process gases are introduced to form or deposit reactant species on the substrates.

There are several design challenges to meeting the thermal requirements of heat treatment apparatuses. For instance, the process chamber temperature must often be quickly varied, such as when beginning or ending thermal processing. Further, furnace downtime should be minimized in order to maximize the number of semiconductor wafers that may be processed on any given day. In like vein, power consumption requirements at high operating temperatures need to be minimized for cost efficiency, while ease of temperature control at low temperatures must be enhanced to avoid excessive operator interference with the semiconductor processing.

Although semiconductor furnaces having multiple interconnected heating coils provide a simple method for heating and cooling the furnace, the entire heating array must be replaced if a single coil fails. Further, this construction can respond to temperature gradients in the process chamber only by increasing power to every heating coil simultaneously, thus causing certain portions of the chamber to overheat in order to eliminate the temperature fluctuation in a different portion of the chamber. This may adversely affect the wafers. This is particularly a concern with the latest, large wafer sizes and more complex integrated circuits, where a single wafer is extremely expensive.

Accordingly, there is a need for an apparatus and method to overcome the aforementioned problems.

### BRIEF SUMMARY OF THE INVENTION

Generally, the present invention discloses an apparatus and method for insulating and controlling temperature in a semiconductor manufacturing environment. More specifically, the invention comprises at least one modular heating element consisting of a base ring and attached insulating blocks. The heating element is designed to be mounted about a semiconductor furnace in order to minimize thermal transfer between the furnace interior and exterior.

In the current embodiment, the base ring or cylinder (also referred to as a “heater ring”) is sized to be fitted around an inner skin of a semiconductor mini-batch furnace. The base ring has multiple channels equidistantly spaced about its inner perimeter, each of which contains a heating coil. The coils may be either removably or permanently affixed within the channels.

Continuing the description of the present embodiment, three heater rings are placed one atop the other in order to completely insulate the furnace's process chamber. Alternate embodiments may use a different number of heater rings, such as two, five, and so on, to surround the process chamber. By using multiple rings and dividing the furnace into separate heating zones, each of which corresponds to a ring, temperature gradients between zones may be easily monitored and controlled by selectively adjusting the power to the coils within one or more rings. Further, should a heating coil fail, only the heater element containing that coil need be removed and replaced. This may be done during operation of the furnace without removing either of the other heater elements.

One embodiment of the present invention has a number of insulating blocks located on the exterior. When viewed in cross-section, such a heater ring may resemble a gear, with the insulating blocks corresponding to gear teeth. The number, thickness, and width of each insulating block may vary, depending on the exact heating/insulating characteristics required.

This embodiment may be adjusted “on the fly” in order to change the heating and insulating characteristics of each ring. Additional spacers of insulating material may be inserted along the height of each ring, into the space between attached insulating blocks. These spacers increase the insulating effect of the heater rings.

In yet another embodiment of the present invention, thermal characteristics of a heater ring may be changed by placing an auxiliary interlocking cylinder along the outside of the ring. A number of interior insulating blocks (“interior insulators”) are affixed to the inside diameter of the cylinder in such a manner that, when the auxiliary cylinder is placed around the heater ring, the interior insulators fit into the spaces between the insulating blocks along the outside of the base ring. Auxiliary cylinders may have insulating blocks arranged in a variety of formats.

### BRIEF DESCRIPTION OF THE DRAWINGS

FIG. 1 displays an exemplary operating environment for an embodiment of the present invention.

FIG. 2 displays a first embodiment of the present invention suitable for use with low-temperature environments.

FIG. 3 displays an electrical schematic of an embodiment in accordance with the present invention.

FIG. 4 displays a top-down view of the embodiment of FIG. 2.

FIG. 5 displays a second embodiment of the present invention suitable for use with medium-temperature environments.

FIG. 6 displays a top-down view of the embodiment of FIG. 5.

FIG. 7 displays a third embodiment of the present invention suitable for use with high-temperature environments.

FIG. 8 displays three heater elements in operation in a suitable operating environment.

FIG. 9 displays the first embodiment of the present invention in operation in a one-skin environment.

FIG. 10 displays the first embodiment of the present invention in operation in a two-skin environment.

FIG. 11 displays a set of insulating spacers as used with an embodiment of the present invention.

FIG. 12 displays an auxiliary cylinder as used with an embodiment of the present invention.

### DETAILED DESCRIPTION OF THE INVENTION, INCLUDING THE BEST MODE

General Overview

Generally, the methods and apparatuses described herein are for insulating and controlling temperature in a semiconductor manufacturing environment. More specifically, the modular heater element described herein is designed to be mounted about a semiconductor furnace's process chamber in order to minimize thermal transfer between the furnace interior and exterior.

In the current embodiment, the base ring or cylinder (also referred to as a “heater ring”) is sized to be fitted around an inner skin of a semiconductor mini-batch furnace. The base ring has multiple channels equidistantly spaced about its inner perimeter. Heating coils of any suitable type, including types well known in the art, may be nested in these channels in order to warm the furnace interior. The coils may be either removably or permanently affixed within the channels.

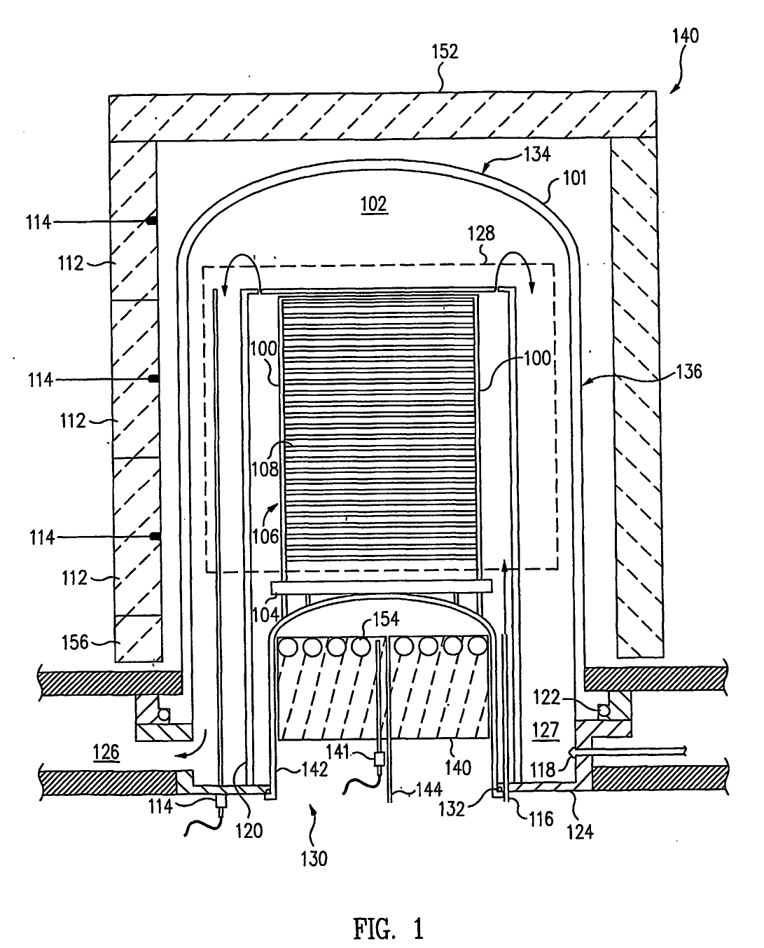

Continuing the description of the present embodiment, multiple heater rings are typically placed one atop the other in order to completely insulate and surround the furnace. In the embodiment of FIG. 1, for example, three heater rings 100 are stacked one atop another to completely surround the sidewalls of the furnace interior. By using multiple rings and dividing the furnace into separate heating zones, each of which corresponds to one or more rings, temperature gradients between zones may be more easily monitored and controlled by selectively adjusting the power to the coils within one or more rings. Further, should a heating coil fail, only the base ring containing that coil need be removed and replaced. This minimizes repair costs in the FIG. 1 embodiment, insofar as two-thirds of the heating coils and insulation are not discarded due to a single coil failure.

Different embodiments include heater rings having different designs to enable the furnace to operate at a wide range of temperatures. Generally speaking, semiconductor fabrication takes place at temperatures ranging from 200 to 1250 degrees Celsius. Because the furnace may operate over different temperature ranges, depending on processes being carried out and on the number of semiconductors being fabricated, differing amounts of insulation may be required at different temperatures.

Less insulation typically yields better heating stability and ease of control. For example, a heater ring using a small amount of insulation minimizes the time taken to decrease temperature when the furnace is overheated when, for example, a target furnace temperature is overshot, because heat may more readily bleed through the furnace walls. Similarly, ease of control is maximized because solid-state power controllers, such as those used in many conventional furnaces, control power more precisely when the steady-state power consumption exceeds approximately three percent of the total power. Continuing the example, more insulation reduces the power necessary to maintain a given temperature, because heat loss through. Accordingly, less insulation is preferable at low temperatures where thermal transfer is a minimal issue, while more insulation is preferable at high temperatures where thermal transfer increases power consumption.

One embodiment has a number of insulating blocks located on the exterior. When viewed in cross-section, such a heater ring resembles a gear, with the insulating blocks corresponding to gear teeth. The number, thickness, and width of each insulating block may vary, depending on the exact heating/insulating characteristics required. For example, a low-temperature heater element has relatively narrow insulating blocks (which may be longitudinally continuous or discontinuous as desired) with large gaps between each block, while a high-temperature heating element has blocks of increased thickness or width, or a greater number of blocks, or a combination thereof. For extremely high temperatures, the insulating blocks may be replaced by a solid cylinder of insulating material. Since the heater rings are modular, one or more rings may easily be changed out when the semiconductor furnace changes its mode of operation from low temperature to high temperature.

Further, this embodiment may be adjusted “on the fly” in order to change the heating and insulating characteristics of each ring. Additional spacers of insulating material may be inserted along the length of each ring, into the space between attached insulating blocks. These spacers increase the insulating effect of the heater rings, thus permitting a user of the present invention to adjust thermal characteristics as desired. Thus, where more insulation is required to minimize power utilization at high temperatures, additional insulation spacers may be added instead of swapping out rings.

In yet another embodiment of the present invention, thermal characteristics of a heater ring may be changed by placing an auxiliary interlocking cylinder along the outside of the ring. The auxiliary insulating cylinder has a diameter slightly exceeding that of the heater ring. Additionally, a number of interior insulating blocks (“interior insulators”) are affixed to the inside diameter of the cylinder in such a manner that, when the auxiliary cylinder is placed around the heater ring, the interior insulators thereon fit into the spaces between the insulating blocks along the outside of the base ring. Auxiliary cylinders may have interior insulators arranged in a variety of formats. For example, one auxiliary cylinder may have a series of insulating blocks arranged such that, when mated with a low-temperature heater ring, the auxiliary cylinder insulating blocks contact the heater ring insulating blocks. This configuration would eliminate any gap between insulating blocks, thus mimicking a very high-temperature insulation configuration. Another auxiliary cylinder may be set up to leave a relatively small space between insulating blocks for use in a medium-temperature environment.

Operating Environment

FIG. 1 displays an exemplary operating environment for a semiconductor minibatch furnace. The furnace 140 generally includes a process chamber 102 having a support 104 adapted for receiving a carrier or boat 106 with a batch of wafers 108 held therein, and heat source 140 having a number of heating elements 100 for raising a temperature of the wafers 108 to the desired temperature for thermal processing. The furnace 140 further includes one or more optical or electrical temperature sensing elements 114, such as a resistance temperature device (RTD) or thermocouple, for monitoring the temperature within the process chamber 102 and/or controlling operation of the heating elements 100.

In the embodiment shown, the temperature sensing element is a profile thermocouple 114 that has multiple independent temperature sensing nodes or points for detecting the temperature at multiple locations within the process chamber 102. Alternately, the temperature sensing element may be a series of spike thermocouples (not shown) extending from the heating elements 100 and unrelated to one another. The furnace 140 can also include one or more injectors 116 for introducing a fluid, gas, or vapor, into the process chamber 102 for processing and/or cooling the wafers 108, and one or more vents or purge ports 118 (only one of which is shown) for introducing a purge element into the process chamber. A liner 120 may be used to increase the concentration of processing gas or vapor near the wafers 108, and to reduce contamination of the wafers from flaking or peeling of deposits that can form on interior surfaces of the process chamber enclosure 101.

Generally, the process chamber 102 is sealed by a seal, such as an o-ring 122, to a platform or baseplate 124 to completely enclose the wafers 108 during thermal processing. Openings for the injectors 116, thermocouples 114 and purge ports 118 are sealed using seals such as O-rings, VCR®, or CF® fittings. Gases or vapor released or introduced during processing are evacuated through an exhaust port 126 formed in a wall of the process chamber 102 or via a plenum 127 of the baseplate 124, as shown in FIG. 1. The process chamber 102 can be maintained at atmospheric pressure during thermal processing or evacuated to near-vacuum via a pumping system (not shown) including one or more roughing pumps, blowers, hi-vacuum pumps, and roughing, throttle and/or foreline valves.

The process chamber enclosure 101 and liner 120 can be made of any metal, ceramic, crystalline or glass material that is capable of withstanding the thermal and mechanical stresses of high temperature and high vacuum operation, and which is resistant to erosion from gases and vapors used or released during processing. Preferably, the process chamber enclosure 101 is made from an opaque, translucent or transparent quartz glass having a sufficient thickness to withstand the mechanical stresses and that resists deposition of process byproducts, thereby reducing potential contamination of the processing environment. Optionally, the process chamber enclosure 101 and liner 120 are made from an opaque quartz that reduces or eliminates the conduction of heat away from the region or processing zone 128 in which the wafers 108 are processed to the seal 122.

In the FIG. 1 embodiment, illustratively, six heating elements are employed. A first heating element 152 is adjacent the top of the process chamber 102, while a second element 154 runs along the chamber bottom. A third heating element 156 encircles the bottom portion of the chamber. The fourth, fifth, and sixth heating elements 100 are functionally and operationally identical, and surround the remainder of the process chamber 102 sides. These three heating elements 100 divide the process chamber into three temperature zones, each of which may be controlled independently of one another. Generally, the heating elements operate to maintain operating temperatures in the process chamber 102 between approximately 250 and 1250 degrees Celsius. The exact operating temperature varies, depending on the wafer load inside the chamber, the type of wafer being fabricated, the process conditions, and so forth. Accordingly, each heater element 100 is fully capable of supporting the entire range of potential operating temperatures.

The Heater Element

1. Low-Temperature Embodiment

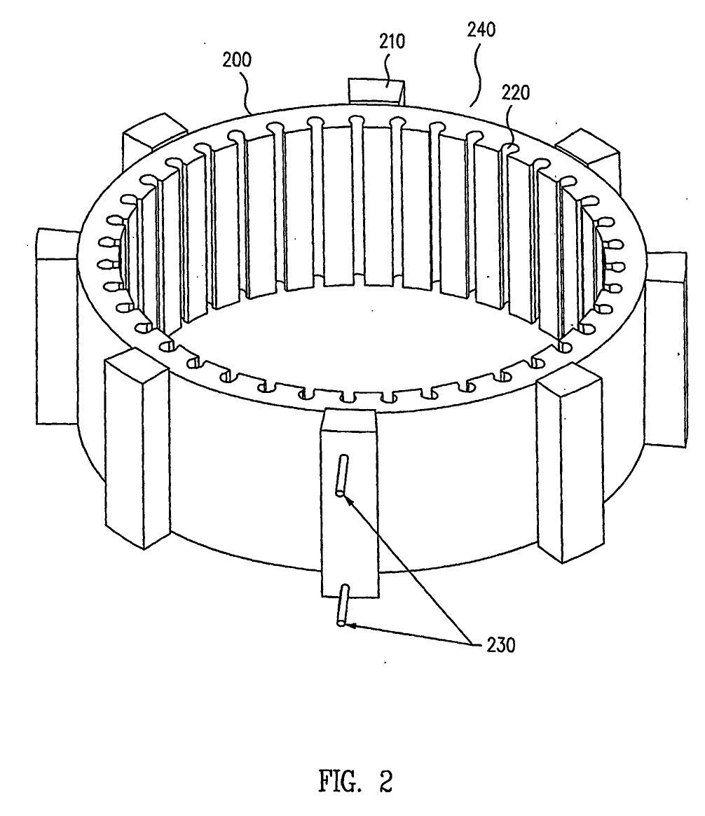

FIG. 2 displays one embodiment 240 of either the heater element 100 or the heating element 156. The heater element 240 shown in FIG. 2 is configured for use in low-temperature environments. The heater element 240 includes a base ring 200 and multiple, spaced insulation blocks 210. Equally spaced about the interior of the base ring 200 is a series of coil recesses 220.

The base ring 200 is typically made of a vacuum-formed fiber having insulating properties. For example, the base ring may be made of a low-density alumina silica fiber insulation. Manufacture of articles using low-density alumina silica fiber insulation is generally known to those skilled in the art. The insulation blocks 210 may be created as an integral part of the base ring 200, or may be later affixed thereto. Any attachment means known to those skilled in the art may serve to fasten the insulation blocks to the base ring.

Generally speaking, the base ring 200 is sized to fit about the exterior of the process chamber 102. The base ring 200 interior may be a small distance from the process chamber 102 exterior wall (as shown in FIG. 1), or may be positioned flush against the chamber. By leaving a small amount of space between the base ring 200 and process chamber 102, the intervening air may distribute heat generated by the heating coils, thus assisting in generating uniform temperature distribution across the wafers, and may also assist in cooling. By mounting the base ring 200 flush against the skin of the process chamber 102, thermal transfer to the interior of the process chamber is reduced, thus minimizing power requirements. Accordingly, different circumstances may call for different size heater elements 100. In the present embodiment, however, the heater ring 100 has an inner diameter of approximately 20.5 inches, an outer diameter of approximately 26.5 inches, and a height of approximately three to nine inches. Typically, multiple heater rings 100 are used with a single furnace. In the present embodiment, a top insulation ring (approximately 3 inches high), three main heater rings (each approximately nine inches high), and a base heater ring (approximately three inches high) are all placed about a single furnace to form a “heater stack.” This heater stack is generally about thirty-six inches high.

Multiple insulation blocks 210 are evenly spaced about the base ring 200 in the present embodiment. Typically, the insulation blocks 210 are made of the same material as the base ring 200, but may be formed from a different type of insulation if desired. Further, although the present embodiment forms each of the insulation blocks 210 from the same material, the various blocks may be made from different insulators if necessary. In the present embodiment, the insulation block 210 width is approximately equal at the outer edge and the edge contacting the base ring 200, although alternate embodiments may increase or decrease the insulation width across the length of the block 210.

Because the heater element 240 shown in FIG. 2 is designed for low-temperature operation, the insulation blocks 210 cover a relatively small percentage of the base ring's 200 overall surface area. At low-temperature operation, thermal loss is relatively minimal. This, in turn, dictates that power requirements are also minimized. Accordingly, by using less insulation, the present embodiment of the heater element 100 yields better heating stability and easier temperature control.

Extending through one of the insulation blocks 210 are a pair of heater studs 230.

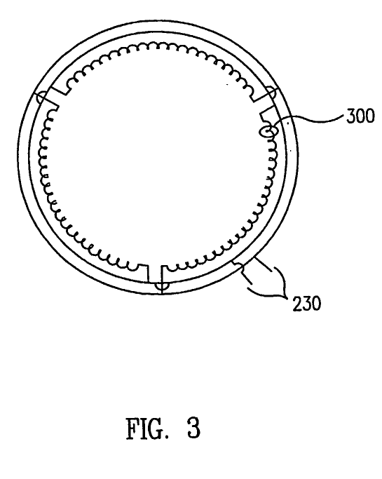

FIG. 3 displays a schematic of the electrical circuit formed by the heater studs 230 and coils 300. The heater studs 230 are electrically connected to the heater coils 300 running throughout the coil recesses 220, and supply power thereto. Taken together, the series of heater coils 300 and heater studs 230 form an electrical loop, with power being supplied to the coils by a power source (not shown). It should be noted that the power source connected to the heater coils 300 by the studs 230 may be in direct or remote physical or electrical connection with the studs. That is, the power source may close the electrical loop shown in FIG. 3, or there may be multiple intervening elements between the studs 230 and the power source. Any method or configuration known to those skilled in the art permitting electrical power to flow through the studs and to the coils is contemplated herein. The heater coils 300, of course, convert electrical energy to heat via a high coil resistance, as well known to those skilled in the art. Thus, by, varying the power supplied to the heater coils 300 via the heater studs 230, the heat generated by the heater element 100 may be easily controlled. Suitable material for the heating coils 300 include nickel-chromium electric resistance allows and iron-chromium-aluminum electric resistance alloys.

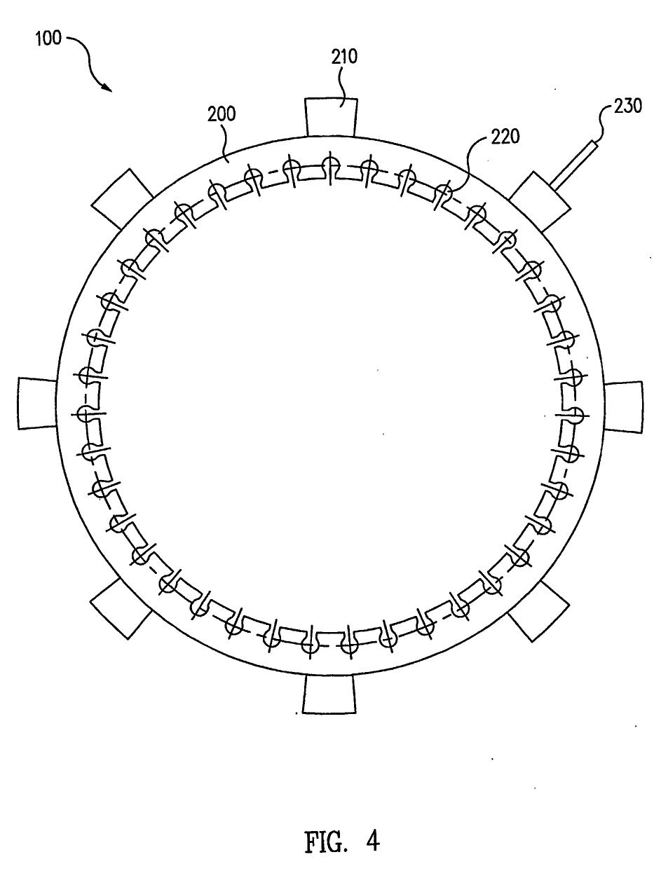

FIG. 4 displays a top-down view of the heater element 100 shown in FIG. 2. The base ring, projecting insulation blocks 210, heater coil recesses 220, and heater studs 230 may all be seen. Generally, the combination of dashed line running through the heater coil recesses and individual lines perpendicular to the dashed line mark the center of each heating coil recess.

2. Medium-Temperature Embodiment

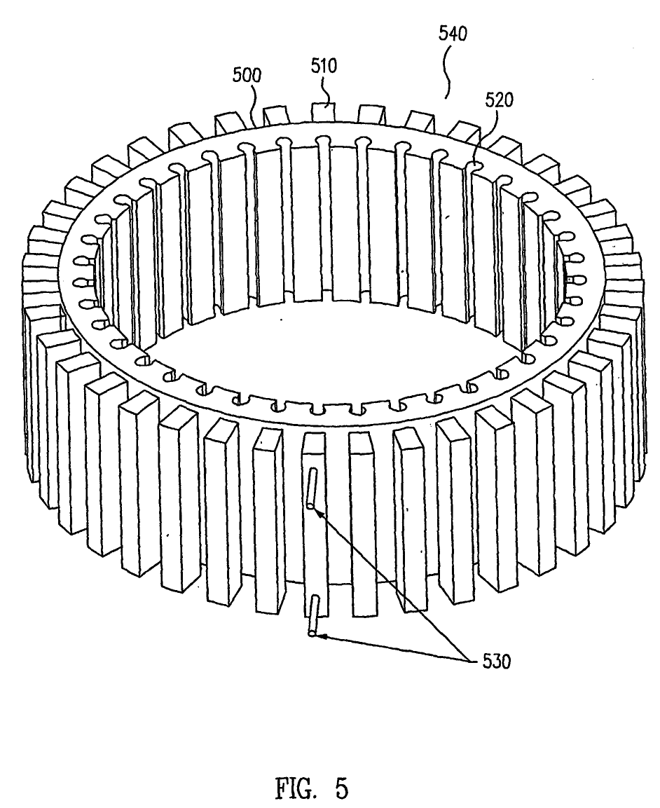

FIG. 5 displays a second embodiment 540 suitable for use in a moderate-temperature environment. The heater element 520 shown in FIG. 5 also has a base ring 500, a series of insulation blocks 510 situated about the exterior of the ring, coil recesses 520 located along the exterior of the base ring, and a pair of heater studs 530. Generally, the configuration of the medium-temperature heater element 540 is similar to that displayed in FIG. 2. Differences between the embodiments are enumerated below.

First, the number of insulating blocks 510 contained in the present embodiment is increased substantially over those in the low-temperature embodiment of FIG. 2. Generally, in the present embodiment one insulating block 510 is located behind each coil recess 520. Approximately 50% of the base ring 500 is covered with insulating blocks 510. By locating one insulating block behind each coil 300, insulation is provided along the outer surface of the ring 500 at the points where surface temperature is hottest, and thus where thermal loss occurs most quickly. However, depending on the thermal properties of the base ring 500, which are determined by the material comprising and physical measurements of the ring, heat radiating out from the coils 300 may be fairly uniformly distributed along the ring exterior. In such a case, the insulating blocks 210 may be positioned at any point along the ring 200 exterior, as desired.

Since a proportionately greater percentage of the base ring 500 is covered by insulating blocks, the heater element 540 shown in FIG. 5 retains more heat than the embodiment shown in FIG. 2. Accordingly, power consumption is relatively smaller in the present embodiment, although heating stability may be sacrificed.

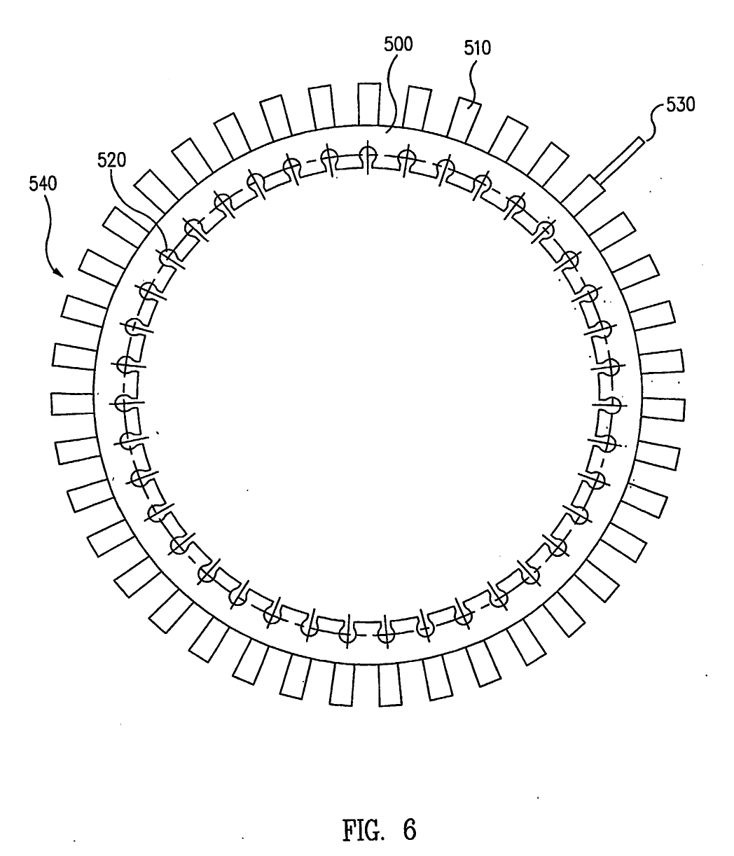

FIG. 6 displays a top-down view of the medium-temperature heater element 100 shown in FIG. 5. Generally, the combination of dashed line running through the heater coil recesses and individual lines perpendicular to the dashed line mark the center of each heating coil recess.

3. High-Temperature Embodiment

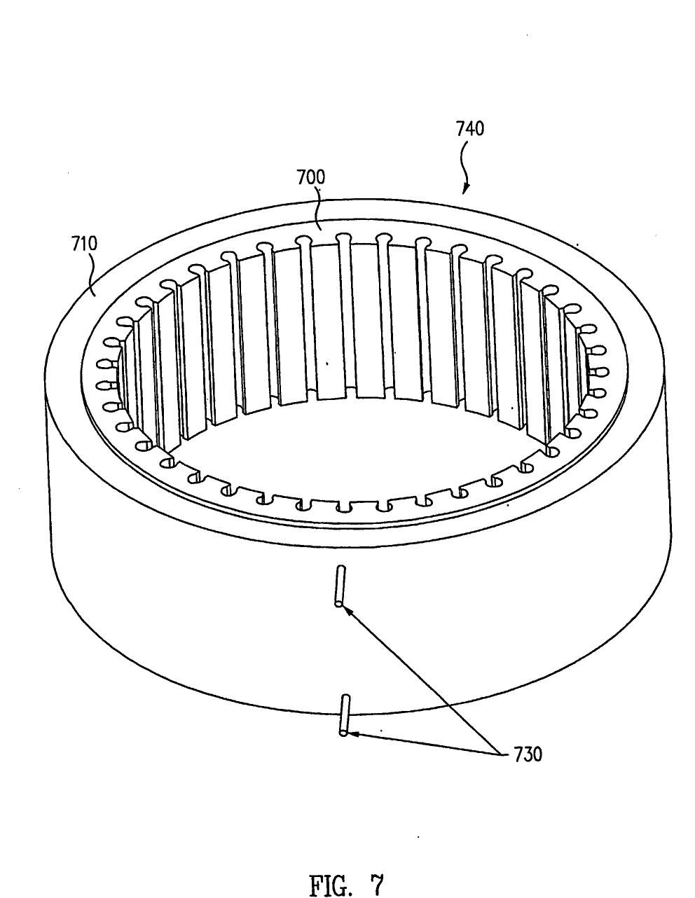

The heater element embodiment 740 shown in FIG. 7 is intended for high-temperature operation, and includes a base ring 700 and heater studs 730, as previously discussed. Here, however, the heater element 740 lacks individual insulating blocks. Instead, an insulating cylinder 710 completely encircles the base ring 700. The cylinder 710 provides maximum insulation and heat retention, which is desirable at high operating temperatures in order to minimize power loss and external heating of the furnace. Generally, the embodiment shown in FIG. 7 operates in a manner similar to that previously discussed.

It should be noted that, although the embodiments shown in FIGS. 2-6 have evenly spaced insulating blocks, there is no requirement that the blocks be uniformly distributed about the perimeter of the base ring. The blocks may be shifted about as necessary during construction of the heater element without adversely affecting the operational characteristics of the element under most circumstances. Further, although the previously-discussed embodiments have multiple coils electrically connected to one another and affixed within the various coil recesses 220, the coils may be separate electrical elements and/or removable in alternate embodiments.

4. The Embodiment in Operation-Multiple Zones of Control

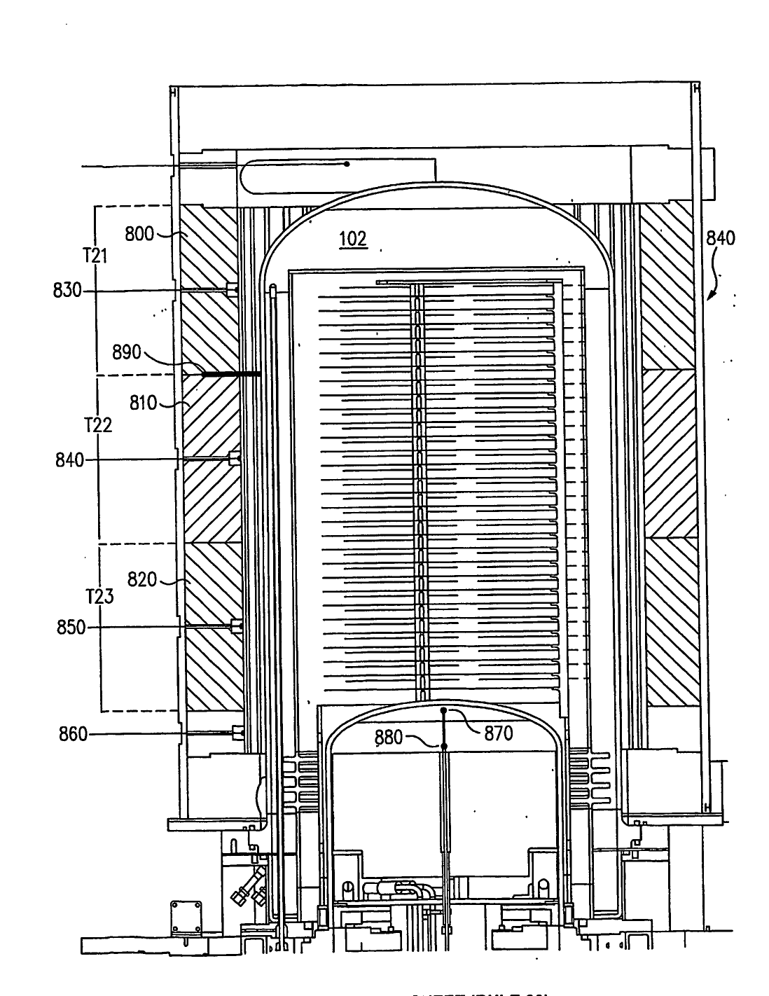

FIG. 8 shows a cross-sectional view of a minibatch furnace 840 with a particular embodiment of the heating elements 100 installed and operating. Generally speaking, the furnace 140 is divided into three separate temperature zones (labeled “TZ1,” “TZ2,” and “TZ3” on FIG. 8), each of which corresponds to a unique heater element 800, 810, 820. The heater elements 800, 810, 820 may be individually placed, removed, and controlled. By permitting each heater element to be installed or replaced separately, only one-third of the heating coils 300 need be switched out if any single coil fails. Although the present embodiment does not permit heater elements 800, 810 and 820 to be replaced while the furnace 840 is in operation, alternate embodiments may permit such “hot-swapping.”

Further, because each heater element 800, 810 and 820 may be independently controlled, the temperature of a single zone TZ1, TZ2, TZ3 may be raised or lowered as necessary to compensate for heat loss from the process chamber 102 and ensure uniform heat distribution across the wafers.

For example, the desired process temperature inside the chamber 102 may be 750 degrees Celsius. As previously mentioned, the temperature at multiple points inside the process chamber 102 may be measured by an array of spike thermocouples 830, 840, 850, 860, 870, a profile thermocouple 880, or another temperature-sensing element. Further, a spike thermocouple may extend through the heating element (for example, spike thermocouple 830) or may occupy a space between adjacent heating elements (for example, spike thermocouple 890). While the average temperature inside the chamber 102 may be 750 degrees Celsius, a single thermocouple 850 may sense a point temperature in zone TZ3 of only 730 degrees Celsius. Rather than increasing the power to every heating element 800, 810, 820 in order to raise the temperature in zone TZ3, two heating elements 800, 810 may be held stable while additional power is routed to the heating element 820 associated with the under-heated zone. Thus, the temperature in zone TZ3 will rise, while the temperature in the other zones TZ1, TZ2 will remain relatively constant (ignoring thermal migration effects). Thus, not only may the temperature in a single zone be raised more quickly thanks to a more directed application of heat, but power is also conserved across the entire system.

One-Skin Environment

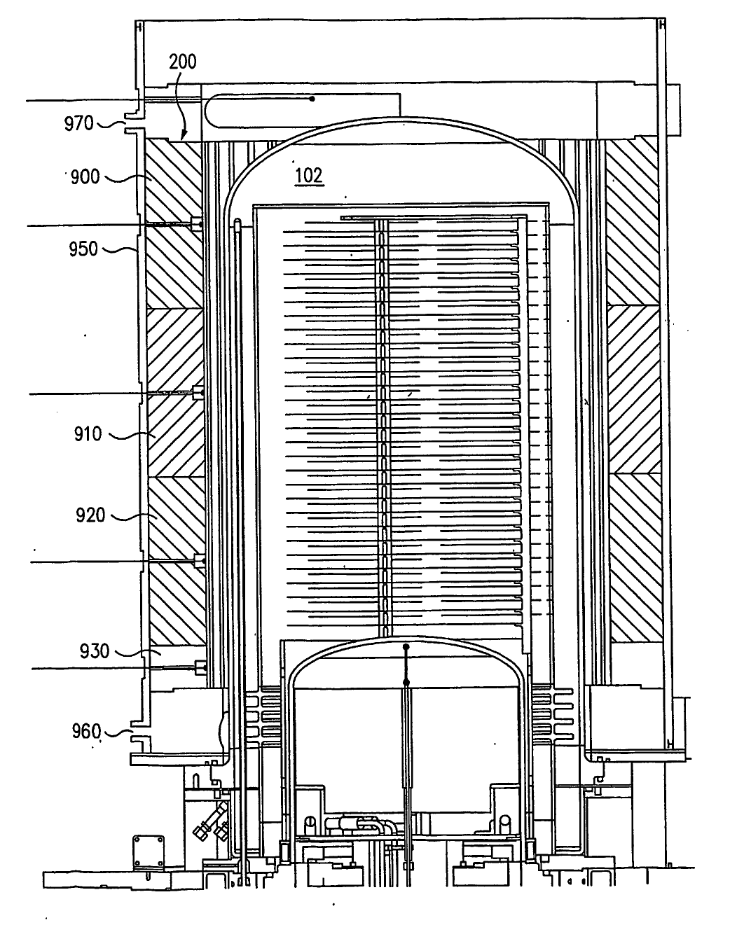

The embodiment shown in cross-section in FIG. 9 displays the various heater elements 900, 910, 920, 930 flush with the inside of the outer skin 950 of the furnace 140. The heater elements are represented by diagonal shading. It should be understood that the diagonal shading represents the heater elements generally; individual components of the heater elements are not shown. In this operating environment, only the insulating blocks 210 (or 510 or 710 depending on the embodiment) actually contact the outer skin 950. The base ring 200 does not. (The cross-section of FIG. 9 is taken through a series of insulating blocks 210.)

Because the insulating blocks 210 are the only portions of the heater elements 900, 910, 920 to contact the outer skin 950, the skin remains relatively cool to the touch. The vast majority of heat generated by the heater coils 300 is prevented from reaching the skin 950 by the shielding properties of the insulating blocks 210 and the air space between the base ring 200 and the outer skin 950. Thus, an operator may safely contact the furnace during operation without risk of being burned.

The outer skin 950 of the furnace 140 may also be provided with one or more inlet ports 960 and outlet ports 970. Air flows into the inlet port 960 at the bottom of the furnace 140 or outer skin 950, up through the spaces between insulating blocks 210 mounted to the base rings 200 of each heater element 900, 910, 920 and 930, and out the outlet port 970. Effectively, the space defined by adjacent insulating blocks, the base ring, and outer skin acts as a chimney. Because heat rises, cool air is drawn through the inlet port 960 and expelled, after heating, through the outlet port 970. The motion of the air acts as a convection cooler, effectively reducing the temperature inside each “chimney” and, by extension, the outer skin 950 and heater elements 900, 910, 920 and 930.

Additionally, each inlet 960 and outlet 970 port may be provided with a cover (not shown). By opening or closing the cover, the convection cooling effect may be utilized or eliminated. Further, the covers may have a variety of operating positions ranging from fully closed to fully opened, thus permitting the exact amount of air drawn through the furnace 140 to be easily regulated. This offers an additional means for temperature regulation not only of the outer skin 950, but also of the heater elements 900, 910, 920 and 930 and the process chamber 102 themselves.

Two-Skin Environment

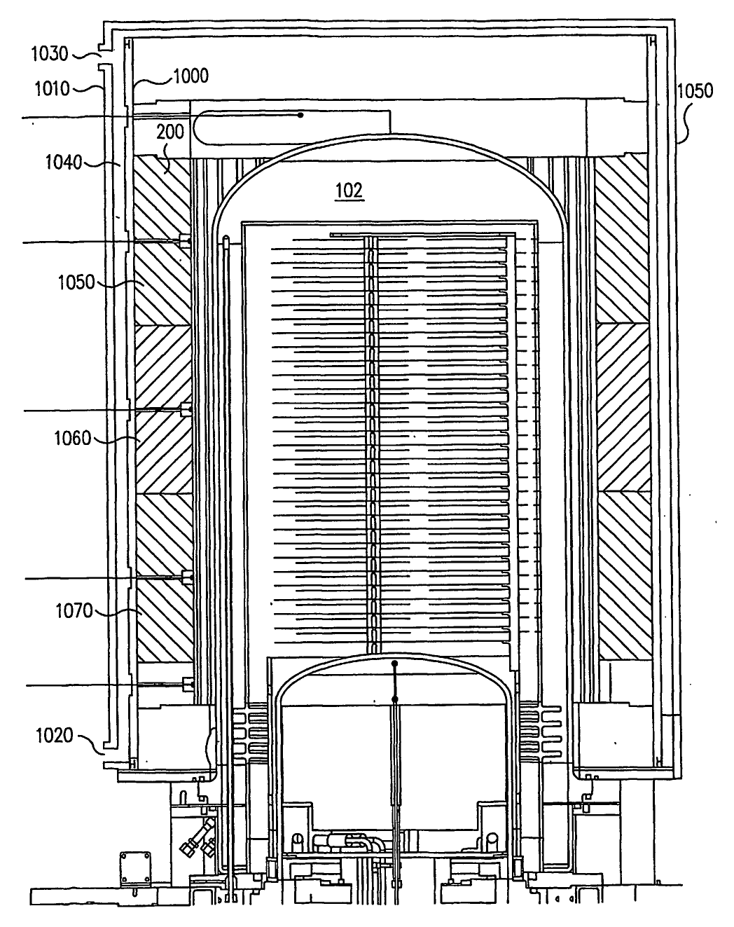

FIG. 10 displays an embodiment of the present invention operating in a furnace 1050 having an inner skin 1000 and outer skin 1010. Generally, the heater elements 1050, 1060, 1070 are positioned between the inner skin 1000 and furnace wall. Again, diagonal shading represents the heater elements generally; specific components of each heater element are not shown. Inlet ports 1020 and outlet ports 1030 may be provided in the surface of the outer skin 1010. Each port may also have a cover capable of being fully or partially opened or closed.

In this environment, the cylindrical chamber 1040 defined by the inner 1000 and outer 1010 skins acts much like the space between insulating blocks 210 discussed in the section above, permitting air to circulate and cool the outer skin via convection. Airflow may be regulated by adjusting the port covers 1020, 1030. In this embodiment, airflow acts primarily to cool the outer skin 1010, making it safe to touch. The effect on the heater elements 100 is minimal, insofar as the air does not flow directly over them.

When the inlet ports 1000 and outlet ports 1010 are completely blocked with an air-tight cover, however, air inside the cylindrical chamber 1040 acts as an additional layer of insulation to prevent heat from escaping during furnace 1050 operation. Alternately, a vacuum pump (not shown) may be fitted to another port opening into the chamber 1040, and a near-vacuum created within the chamber. This near-vacuum space will act as an even more efficient insulator. Either method of insulation (air or vacuum) may assist in maintaining temperatures within the process chamber 102 and in reducing the power requirements of the heater elements.

It will be appreciated that the two-skin embodiment of FIG. 10 is particularly useful with the heating element embodiment of FIG. 7.

Insulating Spacers

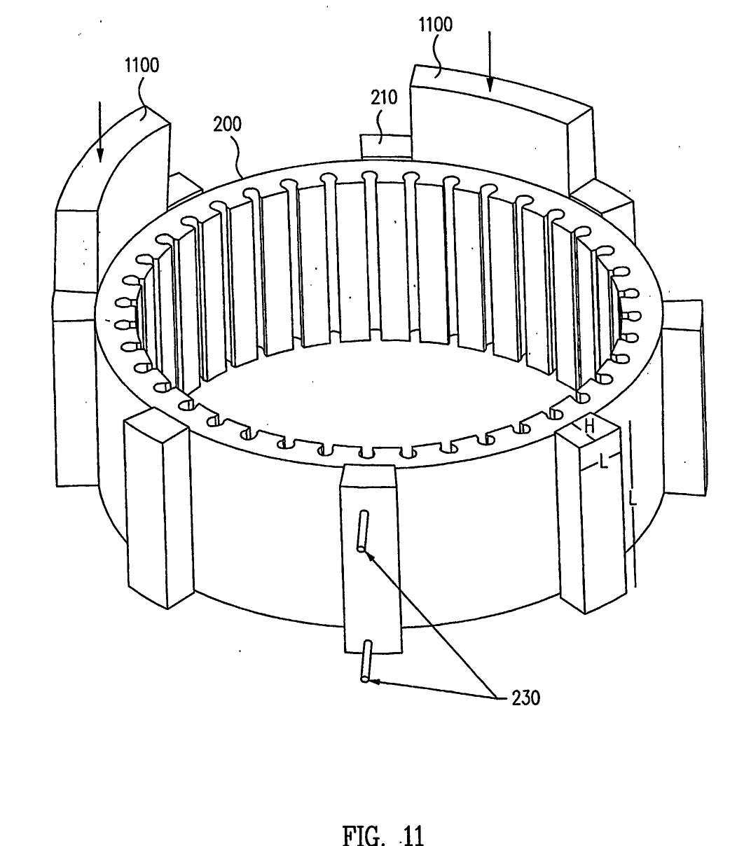

In yet another embodiment of the invention, insulating properties of a heater element 100 may be changed “on the fly” through the addition or removal of various insulating spacers 1100. FIG. 11 shows a heater element 100 including several insulating spacers 1100. The insulating cylinders are typically formed from the same silica fiber and aluminum composite material as a heater element 100, but may be created from different materials having different insulating properties in alternate embodiments.

The insulating spacers 1100 are sized such that they may be placed into the spaces defined by adjacent insulating blocks 210, the exterior of the base ring 200, and the outer skin 950 of the furnace shown in FIG. 9, or the inner skin 1000 of the furnace shown in FIG. 10. The spacers 1100 may simply be slipped into place from the top or bottom of the furnace in order to provide additional insulation without requiring the heater elements 100 to be dismounted and a different element installed. As more insulating spacers 1100 are added, the overall insulating effect of the heater element is enhanced. Thus, by simply adding a number of spacers, a low-temperature heater element 100 (for example, that of FIG. 2) may mimic the characteristics of a medium- or high-temperature heater element (for example, those of FIGS. 5 and 7). Similarly, a medium-temperature heater element 100 may duplicate the effect of a high-temperature element with the addition of sufficient insulating spacers 1100.

Typically, the insulating spacers 1100 have approximately the same width and height as an insulating block 210, but may vary in length depending on the insulating characteristics required. In an alternate embodiment, each insulating spacer 1100 may be approximately three times as high as the base ring 200 or insulating block 210, thus permitting one insulating spacer to be placed along the entirety of the three heater elements 100 while in operation.

Auxiliary Cylinders

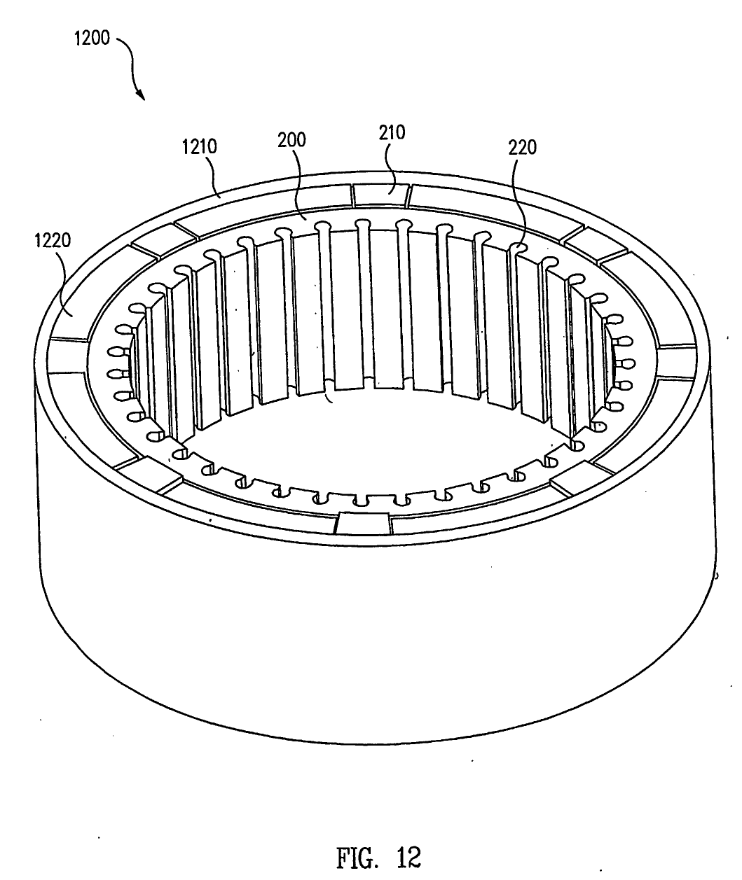

A variant of the insulating spacers 1100, discussed above, is the concept of an auxiliary insulating cylinder 1200. FIG. 12 displays a top-down cross-sectional view of a heater element 100 and matching auxiliary cylinder 1200.

Generally, the auxiliary insulating cylinder 1200 comprises an exterior shell 1210 and at least one interior insulator 1220. The diameter of the shell 1210, as measured to the inner surface thereof, is approximately equal to the diameter of the base ring 200 plus the width of one insulating block 210. In this manner, the inner surface of the shell 1210 snugly contacts the exterior of the insulating blocks 210. The interior insulators 1220 have approximately the same height and width as the insulating blocks 210 of the heater element 100, and in turn fit snugly against the outside of the base ring 200. The number and positioning of the interior insulators 1220 is such that they do not overlap the insulating blocks 210 when the auxiliary insulating cylinder 1200 is fitted about the heater element 100. Effectively, the two items mesh like gears, with the insulating blocks and interior insulators being teeth.

Because the shell 1210 is relatively thin, it provides little or no insulation when in use. Instead, the majority of additional insulation afforded by the auxiliary cylinder 1200 comes from the interior insulators 1220. Thus, the shell 1210 may be made of any material capable of withstanding the operating temperatures of the furnace 140, while the interior insulators are typically formed from the aforementioned silica fiber and aluminum composite. In alternate embodiments, the shell 1210 may also provide an insulating effect, and may be made of the same insulating composite as the interior insulators 1220 and heater element 100.

A variety of auxiliary cylinders 1200 may be designed, manufactured, and employed for each embodiment of the present invention, depending on the additional insulating characteristics desired. For example, the low-temperature embodiment shown in FIG. 2 may have two different varieties of auxiliary insulating cylinder 1200. A first cylinder may have a relatively small number of interior insulators 1220, in order to simulate a medium-temperature heater element 100 when placed about the low-temperature embodiment and to permit air flow through channels formed by the spaces. A second cylinder 1200 may have so many more (or longer) interior insulators 1220 that the entire space between insulating blocks 210 on the heater element 100 is filled. This, in turn, would simulate a high-temperature heater element 100.

### CONCLUSION

As will be recognized by those skilled in the art from the foregoing description of example embodiments of the invention, numerous variations on the described embodiments may be made without departing from the spirit and scope of the invention. For example, a heater element may have different physical measurements, or may be manufactured from different materials. Further, while the present invention has been described in the context of specific embodiments and processes, such descriptions are by way of example and not limitation. Accordingly, the proper scope of the present invention is specified by the following claims and not by the preceding examples.

What is claimed is:

1. A heating element for heating a portion of a semiconductor fabrication furnace, comprising:
a base ring having a one coil recess;
a coil situated within the one coil recess; and
an insulating block affixed to the base ring; wherein
the heating element surrounds substantially less than the entirety of the furnace.

2. The heating element of claim 1, wherein the heating coil is removably situated within the coil recess.

3. The heating element of claim 1, wherein the insulating block is located directly behind the heating coil.

4. The heating element of claim 1, wherein the base ring and insulating block are both made from the same insulating material.

5. The heating element of claim 4, wherein the insulating material is a vacuum-formed silica fiber and aluminum composite.

6. The heating element of claim 1, wherein the insulating block is permanently attached to the base ring.

7. The heating element of claim 6, wherein the heating element is configured for low-temperature operation.

8. The heating element of claim 6, wherein the heating element is configured for medium-temperature operation.

9. The heating element of claim 6, wherein the heating element is configured for high-temperature operation.

10. The heating element of claim 6, further comprising an insulating spacer removably placed between the insulating block and a second adjacent insulating block.

11. The heating element of claim 10, wherein the insulating spacer is temporarily placed during operation of the heater element.

12. The heating element of claim 6, further comprising an auxiliary insulating cylinder, comprising:
an exterior cylindrical shell sized to fit about the combination of the base ring and at least one insulating block; and
an interior insulator sized to fit between the block and an adjacent insulating block.

13. The heating element of claim 12, wherein:
the inner surface of the exterior cylindrical shell contacts the outer surface of the insulating block and outer surface of the adjacent insulating block; and
the inner surface of the interior insulator contacts the outer surface of the base ring.

14. A method for heating and insulating a semiconductor fabrication furnace, comprising:
determining a desired operating temperature;
in response to determining a desired operating temperature, selecting a corresponding heater element configuration;
placing a first and second heater element having the proper configuration about the furnace, the first heater element corresponding to a first and second temperature zone; and
providing power to at least one coil in the first and second heater elements.

15. The method of claim 14, further comprising:
detecting a temperature fluctuation in the first temperature zone; and
in response to detecting the temperature fluctuation, providing additional power to at least one coil in the first heater element.

16. The method of claim 15, further comprising:
detecting that a heater coil in the first heater element is no longer functioning; and
in response to detecting the non-functioning heater coil, replacing the first heater element while leaving the second heater element in place.

17. The method of claim 15, further comprising:
increasing power to the at least one coil in order to increase the operating temperature of the furnace; and
in response to increasing power to the at least one coil, adding an insulation spacer to the first and second heater elements.

18. The method of claim 15, further comprising:
increasing power to the at least one coil in order to increase the operating temperature of the furnace; and
in response to increasing power to the at least one coil, placing an auxiliary insulating cylinder about the first and second heater elements.

19. A heater configuration for insulating a semiconductor fabrication furnace, comprising:
a first heater, said first heater comprising:
a first base ring having at least one first coil recess;
at least one first heating coil situated within the at least one first coil recess; and
at least one first insulating block attached to the first base ring; and
a second heater disposed adjacent to the first heater, the second heater comprising:
a second base ring having at least one second coil recess;
at least one second heating coil situated within the at least one second coil recess;
at least one second insulating block attached to the second base ring; and
a power means for providing power to the at least one first heating coil and at least one second heating coil;
wherein the at least one first heating coil and at least one second heating coil cooperate to maintain a temperature inside the furnace.

20. The heater configuration of claim 19, wherein the first heater may be removed without removing the second heater.
